(19) United States
(12) Patent Application Publication
(10) Pub. No.: US 2024/0215745 A1
(43) Pub. Date: Jul. 4, 2024

(54) MAILBOX DOOR SECURING DEVICE

(71) Applicant: Travis Ruotsalainen, Maple Grove, MN (US)

(72) Inventor: Travis Ruotsalainen, Maple Grove, MN (US)

(21) Appl. No.: 18/092,941

(22) Filed: Jan. 4, 2023

(51) Int. Cl. A47G 29/122; E05C 19/00

(52) U.S. Cl. CPC A47G 29/122; E05C 19/00

(57) ABSTRACT

A mailbox door securing device is disclosed. The mailbox door securing device secures a residential mailbox door against accidental or unintentional opening and prevent environmental access to the interior of the mailbox enclosure. The device includes two (2) primary components: a flexible device and a capture device. The flexible device comprises a first base, a connecting means, a flexible arm, and a pin, while the capture device comprises a second base and a restraining slot. It is noted that the flexible arm is moved along an arcing travel path “a”, such that the pin may engage the restraining slot at an open end and slide to and from a close end along a sliding travel path “b”, to complete the securing process.

### FIELD OF THE INVENTION

This invention relates to mailboxes. In particular, this invention relates to a mailbox door securing device for a mailbox.

### BACKGROUND

Mailboxes come in different sizes, mounting abilities, as well as having varying standards depending on the country the mailbox is located in. In the US, the US Post Office has established guidelines for mail recipients, including mail slot or mailbox size, location, and identification requirements. While the Post Office permitted alternative designs for attached mailboxes and mail slots that met basic size and construction requirements, the same was not true for curbside mailboxes, which postal regulations required be in the form of the traditional dome-rectangular or ‘tunnel-top’ design first established in 1915. In 1978, seven years after the establishment of the restructured US Postal Service, postal authorities at last approved a “contemporary” mailbox specification for alternative designs.

Currently, US curbside mailboxes are classified as (T) Traditional, (C) Contemporary, or (L) Locking. Traditional or Contemporary non-locking curbside mailboxes are approved in three sizes—No. 1, No. 2, or No. 3, measured by minimum interior dimensions. The largest acceptable curbside mailbox is the No. 3, which measures 22.81 inches long, 11 inches wide, and 15 inches in height (58 cm×28 cm×38 cm) at the peak. Locking mailbox designs that provide security for the recipient's incoming mail have fewer restrictions on shape and size, though designs with a slot for incoming mail must be at least 1.75 inches high by 10 inches wide. Residential locking mailboxes cannot require the postal carrier to have a key, by USPS Specifications. Therefore, no USPS approved residential locking mailbox has secure outgoing mail. Installation requirements vary from standard unlocked mailboxes: with locking mailboxes, the incoming mail slot must be 41″-45″ above the roadside surface, and the front of the mailbox must be 6″-8″ back from the curb. USPS specifications for all mailboxes mandate the same, except the placement of the ‘incoming mail area’ varies with a locking mailbox.

Accordingly, it would be desirable to have the door to a curbside mailbox as well as possible other types of mailboxes properly secured with an easy-to-use device. The device attached to the door would keep the door from accidentally being in an open position at unknown times in the case of high winds, inclement weather, accidental jostling, or misalignment of the mailbox door.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of the mailbox door securing device 10, according to the preferred embodiment of the present invention;

FIG. 2 is a perspective view of the mailbox door securing device 10, installed on a mailbox 75, according to the preferred embodiment of the present invention;

FIG. 3, is a front view of the mailbox door securing device 10, installed on a mailbox 75, according to the preferred embodiment of the present invention;

FIG. 4 is a side view of the mailbox door securing device 10, installed on a mailbox 75, according to the preferred embodiment of the present invention; and,

FIG. 5 is a sectional view of the mailbox door securing device 10, as seen along a line I-I, as shown in FIG. 2, according to the preferred embodiment of the present invention.

### DESCRIPTIVE KEY

10 mailbox door securing device
15 flexible device
20 capture device
25 first base
30 connecting means
35 flexible arm
40 pin
45 second base
50 restraining slot
55 travel path “a”
60 open end
65 close end
70 travel path “b”
75 mailbox
80 mailbox enclosure
85 mailbox door
90 hinge
95 opening/securing means
100 post
105 mail indicator flag
110 fastening means
115 travel path “c”
120 travel path “o”

### DESCRIPTION OF THE PREFERRED EMBODIMENTS

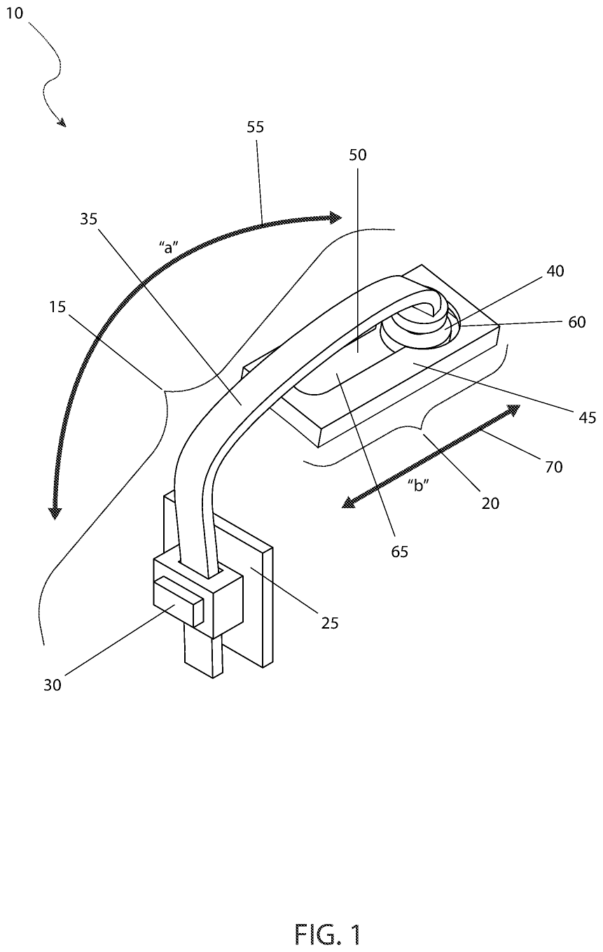

The best mode for carrying out the invention is presented in terms of its preferred embodiment, herein depicted within FIGS. 1 through 5. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one (1) particular configuration shall be shown and described for purposes of clarity and disclosure and not by way of limitation of scope. All of the implementations described below are exemplary implementations provided to enable persons skilled in the art to make or use the embodiments of the disclosure and are not intended to limit the scope of the disclosure, which is defined by the claims.

The terms “a” and “an” herein do not denote a limitation of quantity, but rather denote the presence of at least one (1) of the referenced items.

### 1. Detailed Description of the Figures

Referring now to FIG. 1, a perspective view of the mailbox door securing device 10, according to the preferred embodiment of the present invention is disclosed. The mailbox door securing device 10, secures a residential mailbox door 85 against accidental or unintentional opening and prevent environmental access to the interior of the mailbox enclosure 80. The device 10 includes two (2) primary components: a flexible device 15 and a capture device 20. The flexible device 15 comprises a first base 25, a connecting means 30, a flexible arm 35, and a pin 40, while the capture device 20 comprises a second base 45 and a restraining slot 50. It is noted that the flexible arm 35 is moved along an arcing travel path “a” 55, such that the pin 40 may engage the restraining slot 50 at an open end 60 and slide to and from a close end 65 along a sliding travel path “b” 70, to complete the securing process. Further detail on the use of the device 10 will be provided herein below. It is envisioned that the abovementioned components of the device 10 will be made of a strong durable material including but not limited to metal, plastic, nylon, or the like. The use of any specific material or materials of construction is not intended to be a limiting factor of the present invention.

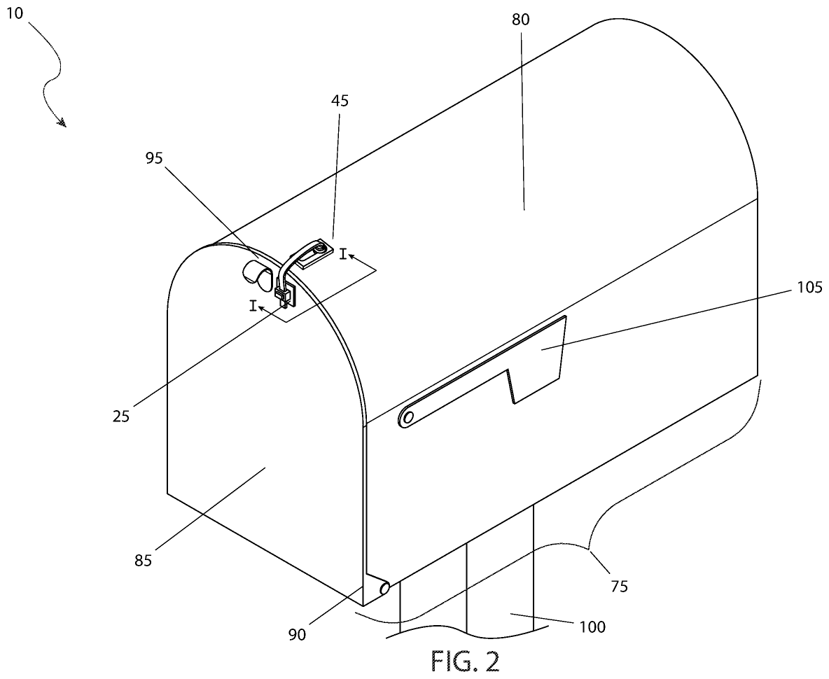

Referring now to FIG. 2, a perspective view of the device 10, installed on a mailbox 75, according to the preferred embodiment of the present invention is depicted. The mailbox 75 is depicted as a common rural mailbox for purposes of illustration. However, other types of mailboxes 75 such as surface-mounted mailboxes, mail chutes, mail slots, and the like can also be used with the teachings of the device 10. As such, the use of any specific type, size, or style of mailbox 75 shall not be interpreted as a limiting factor of the present invention.

The mailbox 75 comprises a mailbox enclosure 80 with a mailbox door 85 secured by a hinge 90 and an opening/securing means 95 in the conventional manner. The mailbox 75 may also comprise a post 100, a mail indicator flag 105, and other amenities such as address indicia, name indicia and the like, even though not specifically shown or indicated. A typical installation of the device 10 would provide for the first base 25 connected to the mailbox door 85 while the second base 45 is connected to the mailbox enclosure 80 at a point mainly farthest from the hinge 90 and nearby to the opening/securing means 95 if so provided. Further detail on the attachment method of the device 10 to the components of the mailbox 75 will be provided herein below.

It is noted that the device 10 is intended for securing the mailbox door 85 of the mailbox 75 to the mailbox enclosure 80 for purposes of accidental opening in the case of high winds, inclement weather, accidental jostling, misalignment of the mailbox door 85 to the mailbox enclosure 80 or the like. It is not intended that the device 10 provide security functionality against malicious opening, theft, or vandalism, as it can be easily opened by manipulation without the use of external functionality such as keys, combinations, tools or the like.

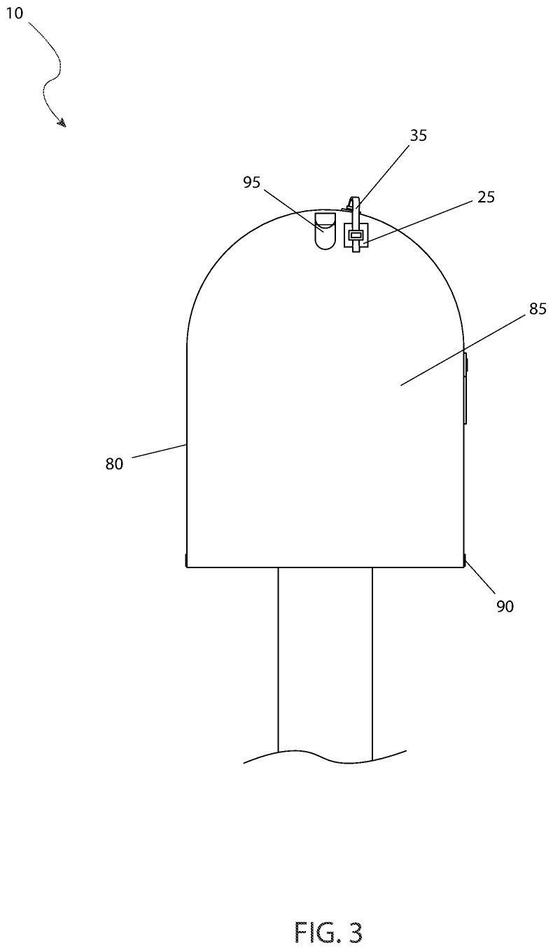

Referring next to FIG. 3, a front view of the device 10, installed on a mailbox 75, according to the preferred embodiment of the present invention is shown. Said view discloses the upward placement of the first base 25 of the device 10 nearest the opening/securing means 95 and most distant from the hinge 90. As such, the flexible arm 35 extends upward and over the mailbox enclosure 80 as shown by the arcing travel path “a” 55 (as depicted in FIG. 1)

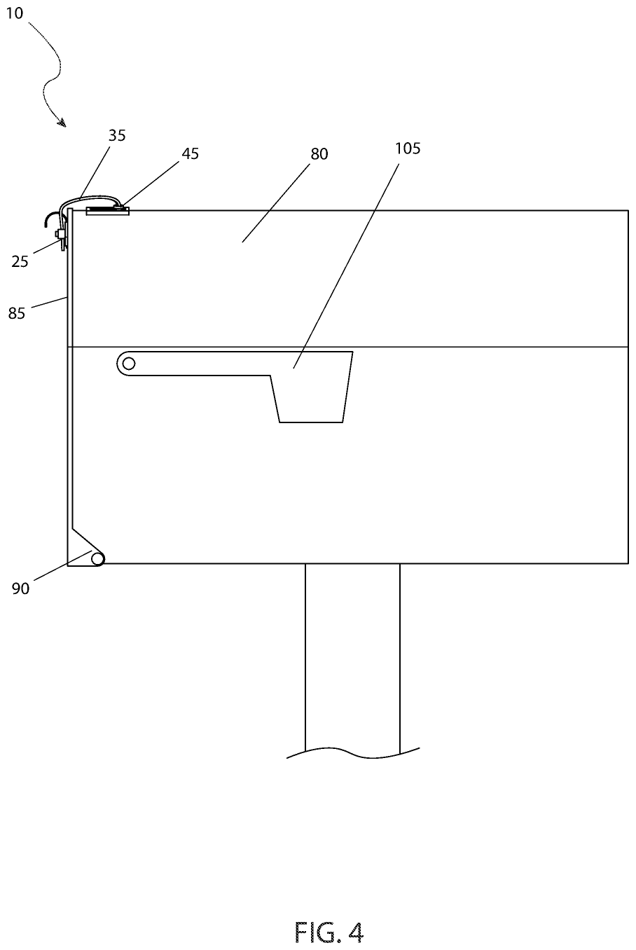

Referring now to FIG. 4, a side view of the device 10, installed on a mailbox 75, according to the preferred embodiment of the present invention is disclosed. The first base 25 is placed upon the mailbox door 85 in a manner allowing the flexible arm 35 to engage as well as disengage the second base 45 as located on the mailbox enclosure 80. Other features of the mailbox 75 (as shown in FIG. 2) include the hinge 90 and the mail indicator flag 105. Such securement features prevent inadvertent opening of the mailbox door 85 not only in inclement weather as aforementioned described, but also from snow and ice buildup, snow and ice discharge such as from snowblowers and snow plows, accidental contact, high winds, and the like.

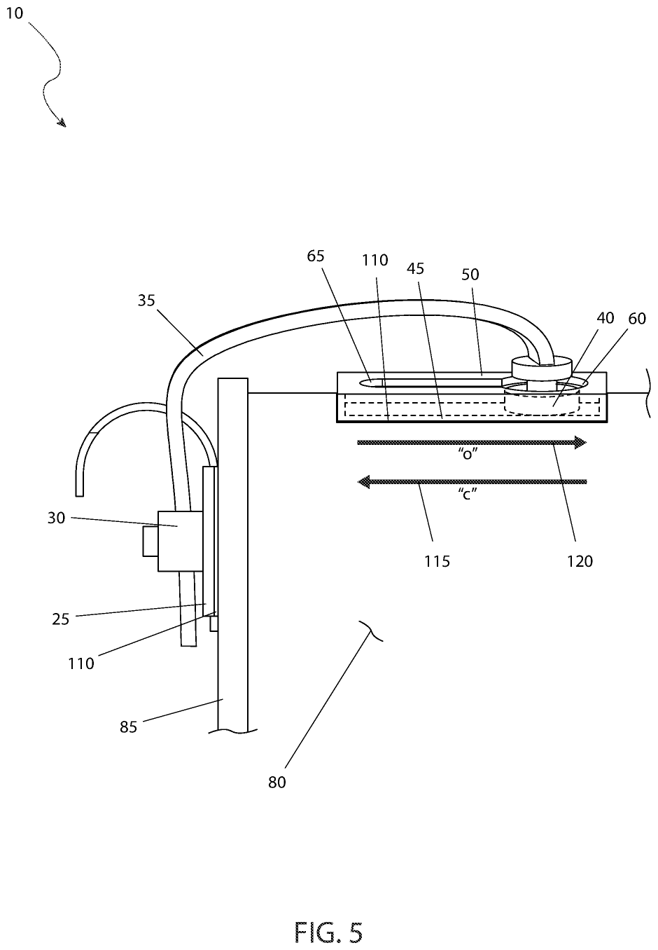

Referring to FIG. 5, a sectional view of the device 10, as seen along a line I-I, as shown in FIG. 2, according to the preferred embodiment of the present invention is depicted. The first base 25 is attached to the mailbox door 85 by use of a fastening means 110, herein depicted as adhesive. However, other types of fastening means 110, such as double-sided tape, bolts, screws, rivets, and the like may also be used with equal effectiveness. Such variation would be used with different types of material of construction of both the device 10 as well as the mailbox 75 (as shown in FIG. 2), such as steel, wood, plastic, or the like. As such, the use of any particular type of fastening means 110 is not intended to be a limiting factor of the present invention. The connecting means 30 forms a mechanical coupling between the first base 25 and the flexible arm 35. In a similar manner, the second base 45 is connected to the mailbox enclosure 80 via use of a fastening means 110 with the same constraints as aforementioned described. The pin 40, permanently attached to the flexible arm 35, is inserted into the open end 60 of the restraining slot 50 during initial placement and slid towards the close end 65 in much the same manner as the chain style door lock along a closing travel path “c” 115. Thus, to open the mailbox door 85, the user must first grasp the pin 40 and slide it from the close end 65 to the open end 60 along an opening travel path “o” 120. It is noted that both the closing travel path “c” 115 and the opening travel path “o” 120 are part of the sliding travel path “b” 70 (as previously disclosed in FIG. 1). This feature of the restraining slot 50 thus provides restraint against the mailbox door 85 opening and requires the mailbox door 85 to be fully closed before the pin 40 and the flexible arm 35 can be removed from the open end 60 of the restraining slot 50.

### 2. Operation of the Preferred Embodiment

The preferred embodiment of the present invention can be utilized by the common user in a simple and effortless manner with little or no training. It is envisioned that the device 10 would be constructed in general accordance with FIG. 1 through FIG. 5. The user would procure the device 10 from conventional procurement channels such as hardware stores, discount stores, home improvement stores, mechanical supply houses, mail order and internet supply houses and the like.

After procurement and prior to utilization, the device 10 would be installed at appropriate locations on the mailbox door 85 for the first base 25 and on the mailbox enclosure 80 for the second base 45 would be chosen such that the flexible arm 35 may travel along the arcing travel path “a” 55 and allow the pin 40 to engage the open end 60 of the restraining slot 50. An appropriate method of applying the fastening means 110 would be selected depending on the type of fastening means 110 used. At this point in time, the device 10 is ready for use.

During utilization of the device 10, to secure the mailbox door 85 in a closed and secure position, the user would manipulate the flexible arm 35 along the arcing travel path “a” 55 so that the pin 40 would engage the open end 60 of the restraining slot 50. The pin 40 is then moved along the closing travel path “c” 115 until further movement is not possible. At this point in time, the mailbox door 85 is securely closed and cannot be opened inadvertently by wind, snow, ice, jostling, vibrations, or the like. Upon which time access to the interior of the mailbox 75 is required, the user would once again manipulate the pin 40 along the opening travel path “o” 120 and remove it, along with the flexible arm 35 from the open end 60 of the restraining slot 50. With the flexible arm 35 now free, the mailbox door 85 may be opened in a conventional manner.

The features of the device 10 are envisioned to provide: a secure “hook-like” lock, the ability to fit any size, style, or type of mailbox 75, the ability to be secured by a wide variety of fastening means 110, the ability to provide extended life to existing mailbox 75 that are experiencing minor damage to the mailbox door 85, the hinge 90, and/or the opening/securing means 95, the ability to prevent mail from becoming blown around and causing litter, and the ability to keep mail safe.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. A mailbox door securing device for securing a mailbox door from accidental or unintentional opening and preventing environmental access to an interior of the mailbox, the securing device comprising:
a first device, the first device comprising:
a first base;
a connecting means;
an arm; and
a pin;
a capture device, the capture device comprising:
a second base; and
a restraining slot.

2. The securing device according to claim 1, wherein the first device is flexible.

3. The securing device according to claim 1, wherein the arm of the first device is flexible.

4. The securing device according to claim 1, wherein the arm of the first device moves along an arcing path such that the pin of the first device engages with the restraining slot of the capture device.

5. The securing device according to claim 1, wherein the mail box is a common rural mailbox.

6. The securing device according to claim 1, wherein the mailbox is a surface-mounted mailbox.

7. The securing device according to claim 1, wherein the mailbox is mail chute.

8. The securing device according to claim 1, wherein the mailbox is a mail slot.

9. The securing device according to claim 1, wherein the mailbox comprises:
a mailbox enclosure;
a mailbox door, the mailbox door coupled to the mailbox enclosure by a first coupling device;
an opening; and
securing means.

10. The securing device according to claim 9, wherein the first coupling device is a hinge.

11. The securing device according to claim 8, wherein the mailbox further comprises:
a post;
a mail indicator flag; and
one or more other amenities.

12. The securing device according to claim 11, wherein the one or more amenities are one or more of: an address indicium, a name indicium, etc.

13. The securing device according to claim 8, wherein the securing device is configured to prevent the mailbox door from accidental opening.

14. The securing device according to claim 13, wherein the accidental opening is high winds.

15. The securing device according to claim 13, wherein the accidental opening is misalignment of the mailbox door.

16. The securing device according to claim 13, wherein the accidental opening is accidental jostling.

17. The securing device according to claim 8, wherein the first base of the first device is placed in an upward placement nearest the opening means of the mailbox.

18. The securing device according to claim 8, wherein the placement of the first device is configured to allow the arm of the first device to extend upward and over the mailbox enclosure.

19. The securing device according to claim 8, wherein the first base of the first device is placed on the mailbox door to allow the arm of the first device to disengage the second base coupled to the mailbox enclosure.

20. The securing device according to claim 8, wherein the first base is attached to the mailbox door by use of a fastening means.
